(19) United States
(12) Patent Application Publication
(10) Pub. No.: US 2012/0188449 A1
(43) Pub. Date: Jul. 26, 2012

(54) VERTICAL SYNC SIGNAL SEPARATION APPARATUS AND METHOD THEREOF

(75) Inventors: Wen-Yi Chen, Hsinchu City (TW); Jau-Yih Lin, New Taipei City (TW); Pang-Chih Liu, Hsinchu City (TW)

(73) Assignee: SUNPLUS TECHNOLOGY CO., LTD., Hsinchu (TW)

(21) Appl. No.: 13/103,109

(22) Filed: May 9, 2011

(30) Foreign Application Priority Data
Jan. 25, 2011 (TW) 100102729

(51) Int. Cl. H04N 5/10

(52) U.S. Cl. 348/529; 348/E05.017

(57) ABSTRACT

Vertical sync signal separation apparatus and method are provided. The vertical sync signal separation apparatus includes a parameter detecting unit, a threshold generating unit and a vertical sync signal generating unit. The parameter detecting unit measures a composite sync signal to obtain a maximum and a second maximum positive pulse width, and a maximum and a second maximum negative pulse width. The threshold generating unit outputs a positive pulse threshold based on the maximum and second maximum positive pulse width, and outputs a negative pulse threshold based on the maximum and second maximum negative pulse width. The vertical sync signal generating unit outputs a vertical sync signal by comparing the composite sync signal against the positive pulse threshold and the negative pulse threshold. As such, this apparatus can correctly separate a vertical sync signal from composite sync signals with different standards, thus increasing its supportability.

### CROSS-REFERENCE TO RELATED APPLICATION

This application claims the priority benefit of Taiwan application serial no. 100102729, filed Jan. 25, 2011. The entirety of the above-mentioned patent application is hereby incorporated by reference herein and made a part of this specification.

### BACKGROUND OF THE INVENTION

1. Field of the Invention

The present invention relates to a composite sync signal processing technology, and more particularly, to an apparatus and a method for separating a vertical sync signal from a composite sync signal.

2. Description of Related Art

A color coding system such as Y (Luminance signal), UV (Chrominance signal) or R (Red), G (Green), B (Blue) is often used in image transmission for HDTV. In other words, the HDTV often transforms an image into a luminance signal (referred to as Y) and two chrominance signals (referred to as U, V), or into a red signal R, a green signal G, and a blue signal B. A composite sync signal is mixed in the luminance signal Y or green signal G.

The composite sync signal consists of a horizontal sync signal, a vertical sync signal, a blank signal or other signals such as an image signal, an audio signal, depending upon the standard of the composite sync signal. Upon receiving the composite sync signal, an image receiving terminal (Rx) performs signal separation to obtain the horizontal and vertical sync signals, such that a display can perform image scan operations according to the horizontal sync signal and the vertical sync signal.

Many techniques can be used to separate the vertical sync signal from the composite sync signal. However, because different image standard has different time characteristics, many separation techniques can only apply for signals of a specific standard, and cannot separate the vertical sync signal from all standard and non-standard composite sync signals. In addition, in some techniques, a reference signal embedded in the composite sync signal can be received and compared in advance to determine whether this sync signal is of a known standard. However, when the sync signal is non-standard, these techniques cannot reliably separate the vertical sync signal. What is needed, therefore, is a separation technique that can apply for all standard and non-standard composite sync signals to reliably separate the desired vertical sync signal therefrom.

### SUMMARY OF THE INVENTION

Accordingly, the present invention is directed to a vertical sync signal separation apparatus which can support all high and low frequencies, different polarities and non-standard composite sync signal and correctly separates the vertical sync signal.

The present invention is also directed to a vertical sync signal separation method which can support all high and low frequencies, different polarities and non-standard composite sync signal and correctly separates the vertical sync signal.

The present invention provides a vertical sync signal separation apparatus including a parameter detecting unit, a threshold generating unit and a vertical sync signal generating unit. The parameter detecting unit receives and measures a composite sync signal to obtain a maximum positive pulse width, a second maximum positive pulse width, a maximum negative pulse width, and a second maximum negative pulse width of the composite sync signal. The threshold generating unit is coupled to the parameter detecting unit to output a positive pulse threshold based on the maximum positive pulse width and the second maximum positive pulse width, and to output a negative pulse threshold based on the maximum negative pulse width and the second maximum negative pulse width. The vertical sync signal generating unit outputs a vertical sync signal by comparing the composite sync signal against the positive pulse threshold and the negative pulse threshold.

In one embodiment, the positive pulse threshold falls in between the maximum positive pulse width and the second maximum positive pulse width, and the negative pulse threshold falls in between the maximum negative pulse width and the second maximum negative pulse width.

In one embodiment, when the vertical sync signal generating unit senses a positive edge of the composite sync signal, a positive edge counter returns to zero and starts counting. In addition, the vertical sync signal generating unit enables the vertical sync signal when the counted time reaches the positive pulse threshold. Similarly, when the vertical sync signal generating unit senses a negative edge of the composite sync signal, a negative edge counter returns to zero and starts counting. In addition, the vertical sync signal disables the vertical sync signal when the counted time reaches the negative pulse threshold.

In one embodiment, when the maximum negative pulse width is greater than the maximum positive pulse width, the maximum positive pulse width is equal to the second maximum positive pulse width, and the second maximum positive pulse width is greater than the second maximum negative pulse width, the negative pulse threshold is greater than and close to the second maximum negative pulse width.

In another aspect, the present invention provides a vertical sync signal separation method. In this method, a composite sync signal is received and measured to obtain a maximum positive pulse width, a second maximum positive pulse width, a maximum negative pulse width, and a second maximum negative pulse width of the composite sync signal. A positive pulse threshold is outputted based on the maximum positive pulse width and the second maximum positive pulse width, and a negative pulse threshold is outputted based on the maximum negative pulse width and the second maximum negative pulse width. A vertical sync signal is outputted by comparing the composite sync signal against the positive pulse threshold and the negative pulse threshold.

In view of the foregoing, embodiments of the present invention sets the positive pulse and negative pulse thresholds based on the positive pulse width and the negative pulse width of the composite sync signal, and use these thresholds to identify the vertical sync signal from the composite sync signal. As such, the vertical sync signal separation apparatus of the above embodiment can support all existing standard and non-standard composite sync signals of different frequencies and different polarities, and correctly separate the vertical sync signal, thus increasing its application scope and performance.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram illustrating an image signal processing system including a vertical sync signal separation apparatus according to one embodiment of the present invention.

FIG. 2 is a block diagram of a vertical sync signal separation apparatus according to one embodiment of the present invention.

FIG. 3 is a flow chart of a vertical sync separation method according to one embodiment of the present invention.

FIG. 4 is a waveform diagram of a composite sync signal of 720p25 standard and a vertical sync signal.

FIG. 5 is a waveform diagram of a composite sync signal of SERR 0.5H standard and a vertical sync signal.

FIG. 6 is a waveform diagram of a composite sync signal of H+V standard and a vertical sync signal in accordance with the first embodiment.

FIG. 7 is a flow chart of a vertical sync signal separation method according to a second embodiment of the present invention.

FIG. 8 is a waveform diagram of the composite sync signal of H+V standard and the vertical sync signal according to the second embodiment.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

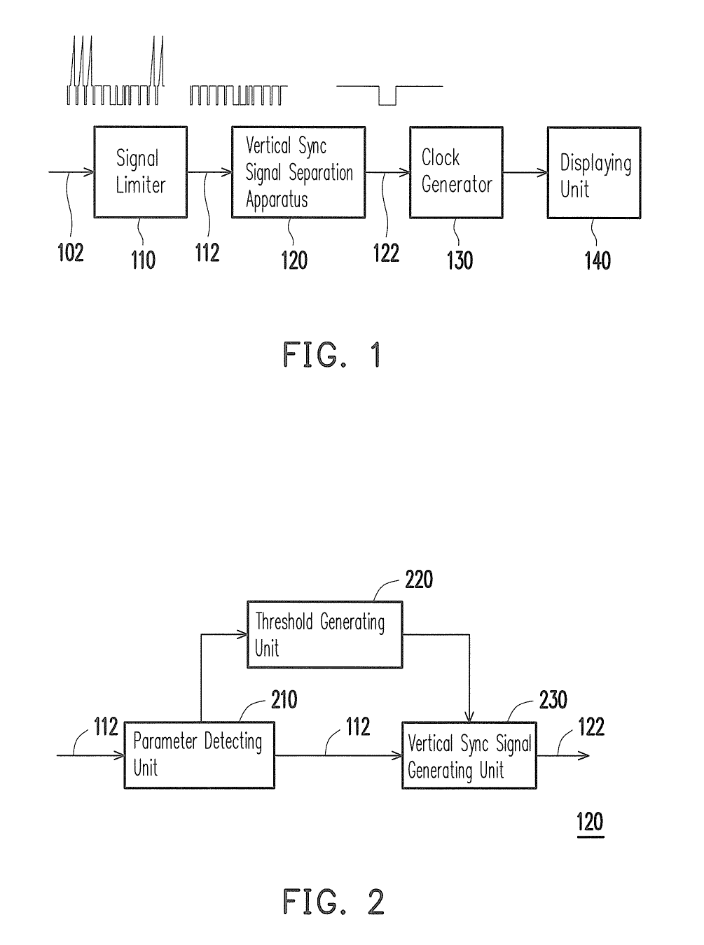

FIG. 1 is a block diagram illustrating an image signal processing system 100 including a vertical sync signal separation apparatus 120 according to one embodiment of the present invention. The image signal processing system 100 includes a signal limiter 110, the vertical sync signal separation apparatus 120, a clock generator 130, and a displaying unit 140. In the present embodiment, the signal limiter 110 receives an image carrying signal 102 (for example, but not limited to, the luminance signal Y in the case of YUV image format in the present embodiment) and limits and hence separates a composite sync signal from the image carrying signal 102.

The vertical sync signal separation apparatus 120 then separates a vertical sync signal 122 from the composite sync signal 112 and outputs the vertical sync signal 122 to the clock generator 130. It is well known to those skilled in the art that the clock generator 130 will then perform image scanning operations to display the image signals on the displaying unit 140 according to the vertical sync signal 122. In addition, it should be understood that the signal limiter 110 would not be necessary if the composite sync signal 112 to be inputted to the vertical sync signal separation apparatus 122 could be directly separated or separated in another manner from the image carrying signal 102.

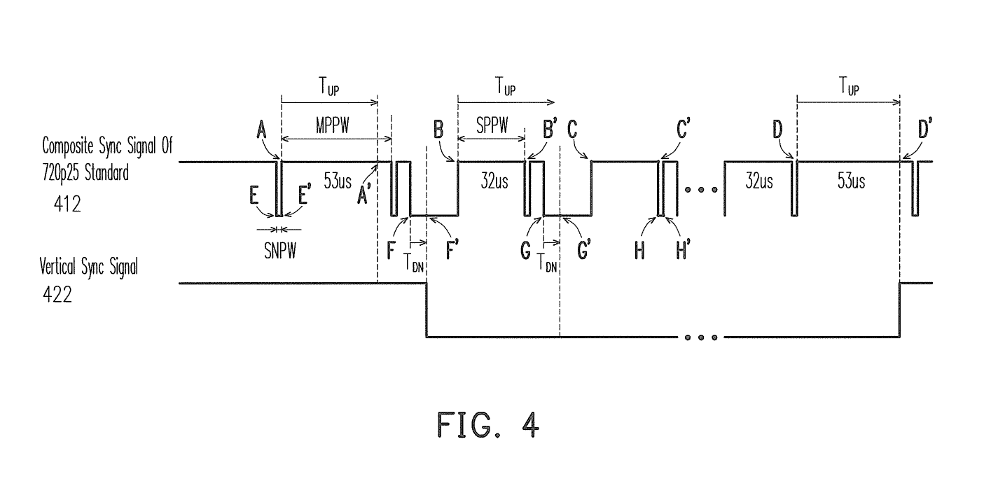

In this regard, the key point of the present embodiment is that the vertical sync signal separation apparatus 120 can support all existing standard and non-standard composite sync signal 112 of different frequencies and different polarities and can correctly separate the vertical sync signal 122, thus increasing the application scope and performance of the vertical sync signal separation apparatus 120. Functional architecture and operation manner of an exemplary vertical sync signal separation apparatus 120 will be described below in detail with reference to FIG. 4.

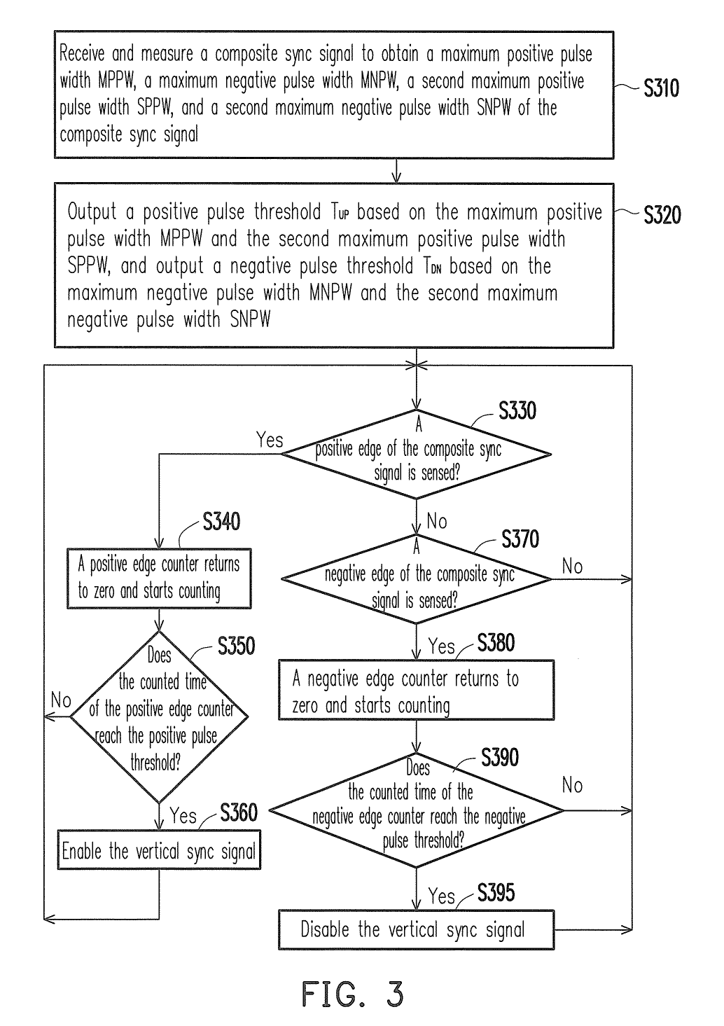

FIG. 2 is a block diagram of a vertical sync signal separation apparatus 120 according to one embodiment of the present invention. FIG. 3 is a flow chart of a vertical sync signal separation method according to one embodiment of the present invention. FIG. 4 is a waveform diagram of the composite sync signal 112 and the vertical sync signal 122, where the composite sync signal is denoted by reference numeral 412 and the vertical sync signal is denoted by reference numeral 422. In the example of FIG. 4, the composite sync signal 412 and the vertical sync signal 422 are of 720p25 standard. The vertical sync signal separation apparatus 120 includes a parameter detecting unit 210, a threshold generating unit 220, and a vertical sync signal generating unit 230. In the present embodiment, the threshold generating unit 220 is coupled to the parameter detecting unit 210 and the vertical sync signal generating unit 230, and the vertical sync signal generating unit 230 is coupled to the parameter detecting unit 210.

Referring to FIG. 2, FIG. 3 and FIG. 4, at step S310, the parameter detecting unit 210 first receives a composite sync signal 412 and obtains related parameters of the composite sync signal 412 by measuring durations of each positive pulse and each negative pulse of the composite sync signal 412. In the present embodiment, the duration of each pulse is referred to as pulse width for simplified description. In addition, the parameter detecting unit 210 stores the positive pulse and negative pulse having the greatest duration and the positive pulse and negative pulse having the second greatest duration into parameters such as maximum positive pulse width MPPW, maximum negative pulse width MNPW, second maximum positive pulse width SPPW and second maximum negative pulse width SNPW (FIG. 4), respectively, and transmits these parameters to the threshold generating unit 220. In the present embodiment, the maximum positive pulse width MPPW of FIG. 4 is 53 us, and the second maximum positive pulse width SPPW is 32 us.

At step S320, the threshold generating unit 220 generates a positive pulse threshold T_{UP} based on the maximum positive pulse width MPPW and the second maximum positive pulse width SPPW, and generates a negative pulse threshold T_{DN} based on the maximum negative pulse width MNPW and the second maximum negative pulse width SNPW. In the present embodiment, people skilled in the art may adjust the positive pulse threshold T_{UP} and the negative pulse threshold T_{DN}, such that the positive pulse threshold T_{UP} falls in between the maximum positive pulse width MPPW and the second maximum positive pulse width SPPW, and the negative pulse threshold T_{DN} falls in between the maximum negative pulse width MNPW and the second maximum negative pulse width SNPW, depending upon actual requirements and the standard of the composite sync signal 412. In FIG. 4, the value of the positive pulse threshold T_{UP} falls in between 53 us and 32 us.

The vertical sync signal generating unit 230 then receives the positive pulse threshold T_{UP} and the negative pulse threshold T_{DN} and outputs the vertical sync signal 422 by comparing the composite sync signal 412 against the positive pulse threshold T_{UP} and the negative pulse threshold T_{DN}. Specifically, in the present embodiment, the vertical sync signal generating unit 230 also includes a positive edge counter PC and a negative edge counter NC (not shown). At step S320, when the vertical sync signal generating unit 230 senses a positive edge of the composite sync signal 412, i.e. when the positive edge counter PC of the vertical sync signal generating unit 230 is triggered by a positive edge of the composite sync signal 412 (for example, at time points A, B, C and D in FIG. 4), the method proceeds to step S340 where the positive edge counter PC starts counting. In addition, when the counted time of the positive edge counter PC reaches the positive pulse threshold T_{UP} (for example, at time points A′ and D′), the method proceeds from step S350 to step S360 where the vertical sync signal generating unit 230 enables the vertical sync signal 422. To this end, in the present embodiment, the vertical sync signal generating unit 230 sets the vertical sync signal 422 to logic 1 such that the vertical sync signal 422 becomes enabled. However, this is for the purpose of illustration only and should not be regarded as limiting. In other words, in various other embodiments, the vertical sync signal 422 can also be set to logic 0 to become enabled.

On the other hand, when the positive edge counter PC receives a negative edge of the composite sync signal 412 before the counted time of the positive edge counter PC reaches the positive pulse threshold T_{UP}, i.e. when the positive edge counter PC and the negative edge counter PC of the vertical sync signal generating unit 230 are triggered by a negative edge of the composite sync signal 412 (for example, at time points B′ and C′), the method proceeds from step S350 back to step S330 to make the positive edge counter PC stop counting, and proceeds from step S370 to step S380 such that the negative edge counter NC returns to zero and then starts counting again (for example, at time points E, F, G and H). When the counted time of the negative time counter NC reaches the negative pulse threshold T_{DN} (for example, at time points F′ and G′), the method proceeds from step S390 to step S395 such that the vertical sync signal generating unit 230 disables the vertical sync signal 422. To this end, in the present embodiment, the vertical sync signal generating unit 230 sets the vertical sync signal 422 to logic 0 to disable the vertical sync signal. However, this is for the purpose of illustration only and should not be regarded as limiting. In other words, in various other embodiments, the vertical sync signal 422 can also be set to logic 1 to become disabled.

Likewise, when the negative edge counter NC receives a positive edge of the composite sync signal 412 before the counted time of the negative edge counter NC reaches the negative pulse threshold T_{DN}, i.e. when the positive edge counter PC and the negative edge counter NC of the vertical sync signal generating unit 230 are triggered by the positive edge of the composite sync signal 412 (for example, at the time points E′ and H′), the method proceeds from step S390 back to step S330 to make the negative edge counter NC stop counting, and proceeds to step S340 such that the positive edge counter PC returns to zero and then starts counting again.

As described above, the vertical sync signal separation apparatus 120 determines and separates the vertical sync signal 422 based on related parameters of the inputted composite sync signal 412. Therefore, the vertical sync signal separation apparatus 120 can support composite sync signals of multiple standards and different frequencies. Because the manner of determining the positive pulse and negative pulse of the vertical sync signal separation apparatus 120 of the present embodiment does not vary with the polarity of the composite sync signal, i.e. the transposition of high and low voltage level of the positive pulse and negative pulse does not affect the generation of the vertical sync signal. Therefore, the vertical sync signal separation apparatus of the present embodiment can also support composite sync signals of different polarities (at least including composite sync signals of the standards such as 720p23, 720p24, 720p25, SERR, SERR 0.5H, H EOR V and H+V).

In addition, the positive edge counter PC and the negative edge counter NC of the above vertical sync signal generating unit 230 are different counters. In another embodiment, the positive edge counter PC and the negative edge counter NC may also be the same counter. This counter returns to zero and then starts counting upon being triggered by the positive edge or negative edge of the composite sync signal 412. When triggered by the positive edge of the composite sync signal 412, the counter determines whether to enable the vertical sync signal by determining whether the counted time reaches the positive pulse threshold T_{UP}. Similarly, when triggered by the negative edge of the composite sync signal, the counter determines whether to disable the vertical sync signal by determining whether the counted time reaches the negative pulse threshold T_{DN}. Other operations and procedures of the counter are similar to those of the positive edge counter PC and the negative edge counter NC as described above and, therefore, explanation thereof is not repeated herein.

On the other hand, in the present embodiment, the parameter detecting unit 210 continuously measures and updates the related parameters of the composite sync signal 412, such that the threshold generating unit 220 can automatically and dynamically adjust the positive pulse threshold T_{UP} and the negative pulse threshold T_{DN}. This way the vertical sync signal generating unit 230 can continuously output correct vertical sync signal.

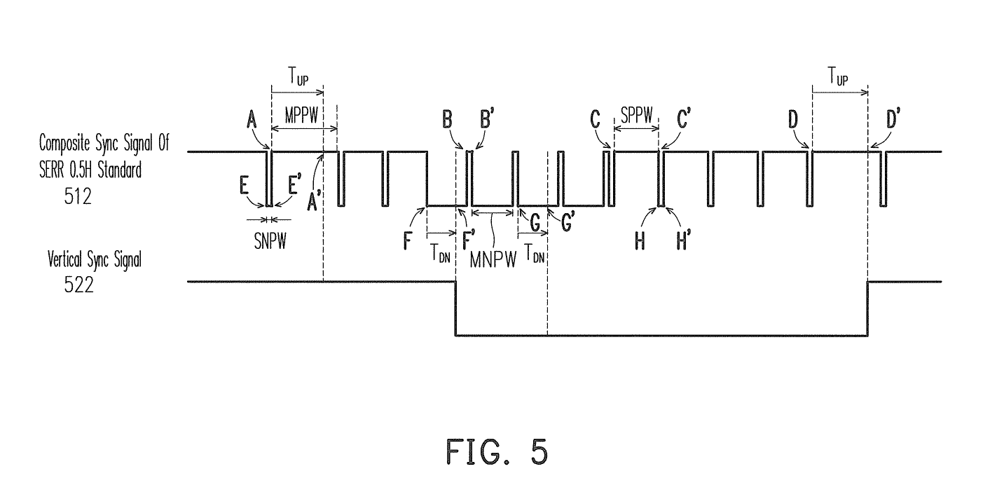

Another embodiment of the present invention is described below by way of example using a composite sync signal of another standard. As shown in FIG. 5, FIG. 5 is a waveform diagram of a composite sync signal 512 of SERR 0.5H standard and a vertical sync signal 522. The determining manner and operations of the present embodiment are the same as in the first embodiment and, therefore, explanation thereof is not repeated herein.

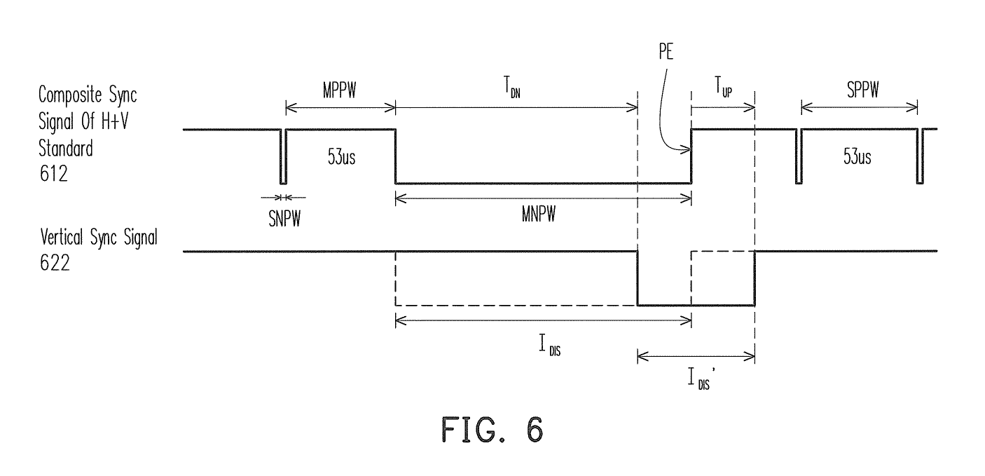

FIG. 6 illustrates a waveform diagram of a composite sync signal 612 of H+V standard and a vertical sync signal 622 in accordance with the first embodiment. The broken line part of the vertical sync signal 622 shows the ideal waveform, while the solid line part shows the practical waveform of the vertical sync signal 622 after determining according to the first embodiment. In this embodiment, both the maximum positive pulse width MPPW and the second positive pulse width SPPW are 53 us. The composite sync signal 612 of H+V standard has a positive pulse PE only at a tail end of a disabling period I_{DIS} of the ideal vertical sync signal 622, with no pulse at other area of the disabling period I_{DIS}. In addition, the threshold generating unit 220 of FIG. 2 may obtain a negative pulse threshold T_{DN} between the maximum negative pulse width MNPW and the second maximum negative pulse width SNPW randomly or through calculation in another manner. This results in the disabling period I_{DIS}′ of the practical vertical sync signal 622 being over short, thus leading to an incorrect clock.

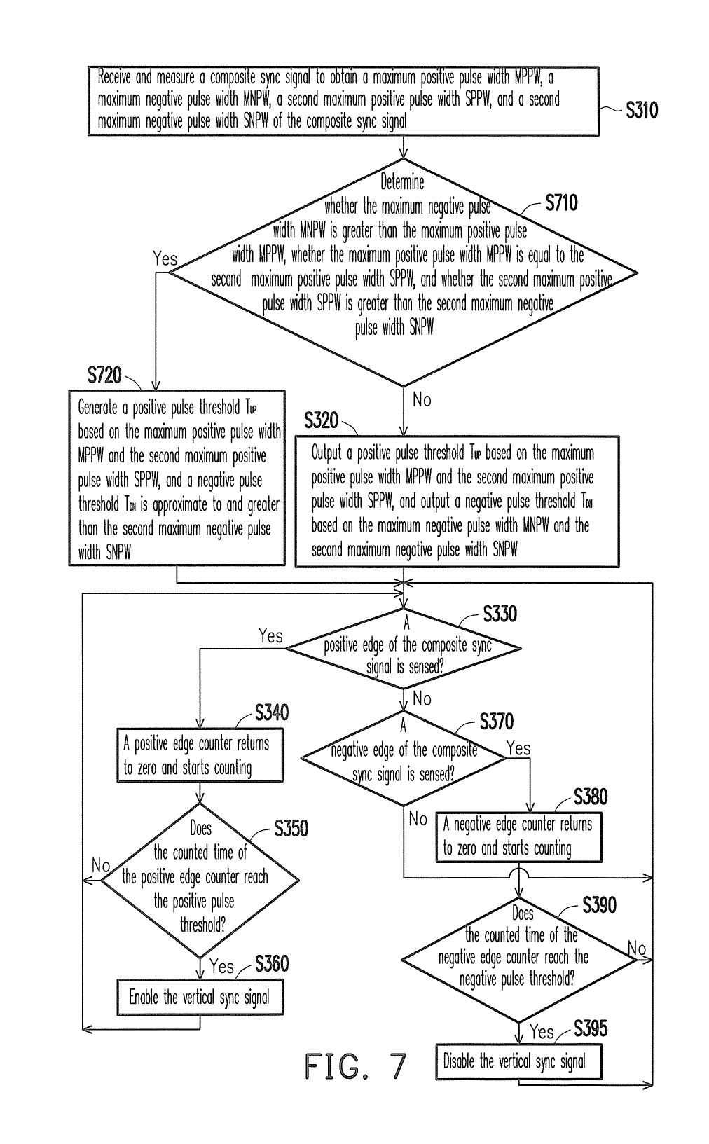

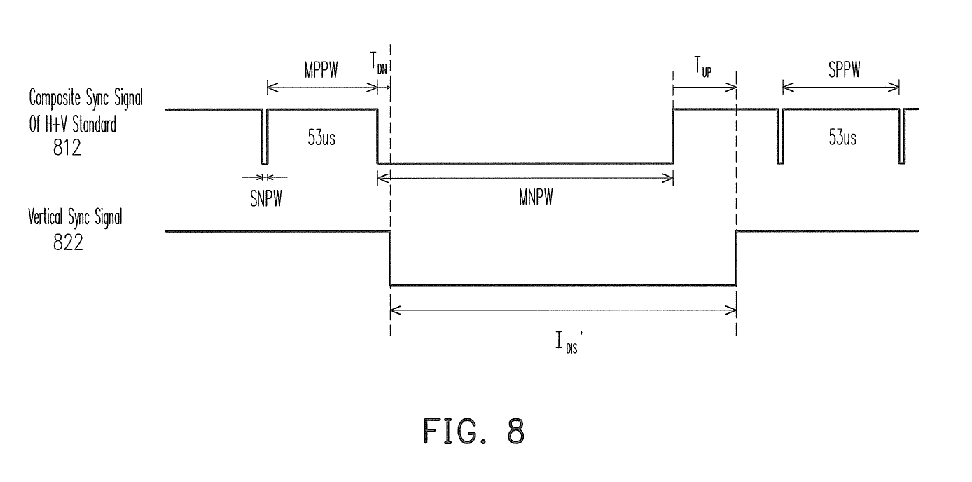

Accordingly, a second embodiment of the present invention is provided with reference to the functional architecture of FIG. 2, the operation procedures of FIG. 7, and the waveform diagram of FIG. 8, in order to address the above problem that the vertical sync signal 822 cannot be correctly identified from the composite sync signal 812 of H+V standard. FIG. 7 is a flow chart of a vertical sync signal separation method according to the second embodiment of the present invention. FIG. 8 is a waveform diagram of the composite sync signal 812 of H+V standard and the vertical sync signal 822 according to the second embodiment.

Referring to FIG. 2, FIG. 7 and FIG. 8, the present embodiment and the first embodiment are different in that the parameter detecting unit 210 receives the composite sync signal 812 and measures related parameters of the composite sync signal 812 at step S310, and the threshold generating unit 220 of the present embodiment determines characteristics of the composite sync signal 812 of H+V standard at step S710, i.e. determine whether the maximum negative pulse width MNPW is greater than the maximum positive pulse width MPPW, whether the maximum positive pulse width MPPW is equal to the second maximum positive pulse width SPPW, and whether the second maximum positive pulse width SPPW is greater than the second maximum negative pulse width SNPW (i.e. MNPW>MPPW=SPPW>SNPW).

When the conditions of step S710 are satisfied, it indicates that the composite sync signal 812 is of H+V standard. Therefore, the method proceeds to step S720, where the negative pulse threshold T_{DN} generated by the threshold generating unit 220 should be approximately equal to the second maximum negative pulse width SNPW but slightly greater than the second maximum negative pulse width SNPW (i.e. T_{DN}≈SNPW and T_{DN}>SNPW). In addition, at step S720, the generation and determining manner of the positive pulse threshold T_{UP} are the same as in the first embodiment. On the contrary, if the conditions of step S710 are not satisfied, it indicates that the composite sync signal 812 is of another standard. Therefore, the method can proceed according to the operation procedure of the first embodiment. As such, in the vertical sync signal 822 of FIG. 8, the clock error caused by the over-short disabling period IDIS′ can be avoided.

In summary, embodiments of the present invention sets the positive pulse and negative pulse thresholds based on the positive pulse width and the negative pulse width of the composite sync signal, and use these thresholds to identify the vertical sync signal from the composite sync signal. As such, the vertical sync signal separation apparatus 120 of the above embodiment can support all existing standard and non-standard composite sync signal of different frequencies and different polarities, and correctly separate the vertical sync signal, thus increasing its application scope and performance. It should be understood that, if the composite sync signal of H+V standard is processed in the manner described in the first embodiment, the vertical sync signal can also be separated and the above technical results can also be achieved. Besides, the second embodiment incorporates the determining of the composite sync signal of H+V standard to address the clock error problem caused by over-short disabling period of the vertical sync signal.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A vertical sync signal separation apparatus comprising:
a parameter detecting unit adapted to receive and measure a composite sync signal to obtain a maximum positive pulse width, a second maximum positive pulse width, a maximum negative pulse width, and a second maximum negative pulse width of the composite sync signal;
a threshold generating unit coupled to the parameter detecting unit to output a positive pulse threshold based on the maximum positive pulse width and the second maximum positive pulse width, and to output a negative pulse threshold based on the maximum negative pulse width and the second maximum negative pulse width; and
a vertical sync signal generating unit adapted to output a vertical sync signal by comparing the composite sync signal against the positive pulse threshold and the negative pulse threshold.

2. The vertical sync signal separation apparatus according to claim 1, wherein the positive pulse threshold falls in between the maximum positive pulse width and the second maximum positive pulse width, and the negative pulse threshold falls in between the maximum negative pulse width and the second maximum negative pulse width.

3. The vertical sync signal separation apparatus according to claim 2, wherein the vertical sync signal generating unit comprises:
a positive edge counter returning to zero and starting counting upon sensing a positive edge of the composite sync signal, and enabling the vertical sync signal when the counted time reaches the positive pulse threshold; and
a negative edge counter returning to zero and starting counting upon sensing a negative edge of the composite sync signal, and disabling the vertical sync signal when the counted time reaches the negative pulse threshold.

4. The vertical sync signal separation apparatus according to claim 3, wherein the positive edge counter stops counting when the positive edge counter receives the negative edge of the composite sync signal before its counted time reaches the positive pulse threshold, and the negative edge counter stops counting when the negative edge counter receives the positive edge of the composite sync signal before its counted time reaches the negative pulse threshold.

5. The vertical sync signal separation apparatus according to claim 2, wherein the vertical sync signal generating unit comprises:
a counter returning to zero and starting counting upon sensing a positive edge of the composite sync signal, and enabling the vertical sync signal when the counted time reaches the positive pulse threshold, and
the counter returning to zero and starting counting upon sensing a negative edge of the composite sync signal, and disabling the vertical sync signal when the counted time reaches the negative pulse threshold.

6. The vertical sync signal separation apparatus according to claim 1, wherein when the maximum negative pulse width is greater than the maximum positive pulse width, the maximum positive pulse width is equal to the second maximum positive pulse width, and the second maximum positive pulse width is greater than the second maximum negative pulse width, the negative pulse threshold is greater than and close to the second maximum negative pulse width.

7. The vertical sync signal separation apparatus according to claim 1, wherein the standard of the composite sync signal is one of 720p25, 720p24, 720p23, SERR, H EOR V, SERR0.5H and H+V.

8. The vertical sync signal separation apparatus according to claim 1, wherein the parameter detecting unit continuously measures and updates the maximum positive pulse width, the second maximum positive pulse width, the maximum negative pulse width, and the second maximum negative pulse width, such that the threshold generating unit dynamically adjusts the positive pulse threshold and the negative pulse threshold.

9. A vertical sync signal separation method comprising:
receiving and measuring a composite sync signal to obtain a maximum positive pulse width, a second maximum positive pulse width, a maximum negative pulse width, and a second maximum negative pulse width of the composite sync signal;
outputting a positive pulse threshold based on the maximum positive pulse width and the second maximum positive pulse width, and outputting a negative pulse threshold based on the maximum negative pulse width and the second maximum negative pulse width; and
outputting a vertical sync signal by comparing the composite sync signal against the positive pulse threshold and the negative pulse threshold.

10. The vertical sync signal separation method according to claim 9, wherein the positive pulse threshold falls in between the maximum positive pulse width and the second maximum positive pulse width, and the negative pulse threshold falls in between the maximum negative pulse width and the second maximum negative pulse width.

11. The vertical sync signal separation method according to claim 10, wherein the step of outputting the vertical sync signal comprises:
S330, determining whether a positive edge of the composite sync signal is sensed, if yes, executing step S340, otherwise executing step S370;
S340, returning a counter to zero and starting counting;
S350, determining whether the counted time of the counter reaches the positive pulse threshold, if yes, executing step S360, otherwise executing step S330;
S360, enabling the vertical sync signal and returning to step S330;
S370, determining whether a negative edge of the composite sync signal is sensed, if yes, executing step S380, otherwise executing step S330;
S380, returning the counter to zero and starting counting;
S390, determining whether the counted time of the counter reaches the negative pulse threshold, if yes, executing step S395, otherwise returning to step S330; and
S395, disabling the vertical sync signal and returning to step S330.

12. The vertical sync signal separation method according to claim 10, wherein the step of outputting the vertical sync signal comprises:
S330, determining whether a positive edge of the composite sync signal is sensed, if yes, executing step S340, otherwise executing step S370;
S340, returning a positive edge counter to zero and starting counting;
S350, determining whether the counted time of the positive edge counter reaches the positive pulse threshold, if yes, executing step S360, otherwise executing step S330;
S360, enabling the vertical sync signal and returning to step S330;
S370, determining whether a negative edge of the composite sync signal is sensed, if yes, executing step S380, otherwise executing step S330;
S380, returning a negative edge counter to zero and starting counting;
S390, determining whether the counted time of the negative edge counter reaches the negative pulse threshold, if yes, executing step S395, otherwise returning to step S330; and
S395, disabling the vertical sync signal and returning to step S330.

13. The vertical sync signal separation method according to claim 9, wherein when the maximum negative pulse width is greater than the maximum positive pulse width, the maximum positive pulse width is equal to the second maximum positive pulse width, and the second maximum positive pulse width is greater than the second maximum negative pulse width, the negative pulse threshold is greater than and close to the second maximum negative pulse width.

14. The vertical sync signal separation apparatus according to claim 9, wherein the standard of the composite sync signal is one of 720p25, 720p24, 720p23, SERR, H EOR V, SERR0.5H and H+V.

15. The vertical sync signal separation apparatus according to claim 1, further comprising continuously measuring and updating the maximum positive pulse width, the second maximum positive pulse width, the maximum negative pulse width, and the second maximum negative pulse width, so as to dynamically adjusts the positive pulse threshold and the negative pulse threshold.
